(19) United States
(12) Patent Application Publication
(10) Pub. No.: US 2024/0168437 A1
(43) Pub. Date: May 23, 2024

(54) METASURFACE STRUCTURE AND RELATED ARTICLE AND METHOD

(71) Applicant: City University of Hong Kong, Kowloon (HK)

(72) Inventors: Dangyuan Lei, Kowloon (HK); Yulong Fan, Kowloon (HK); Zhuochao Wang, Kowloon (HK); Yuan Liao, Kowloon (HK)

(21) Appl. No.: 18/503,497

(22) Filed: Nov. 7, 2023

Related U.S. Application Data
(60) Provisional application No. 63/427,225, filed on Nov. 22, 2022.

(51) Int. Cl. G03H 1/26; B42D 25/328; G02B 1/00

(52) U.S. Cl. CPC G03H 1/2645; B42D 25/328; G02B 1/002; G03H 2001/266

(57) ABSTRACT

There is provided a metasurface structure including a plurality of sub-wavelength structures operable to manipulate optical signal/radiation to which metasurface structure is exposed to or irradiated with. The plurality of sub-wavelength structures is arranged such that the metasurface structure is operable to display a first image based on image data embedded or encoded by the sub-wavelength structures when the metasurface structure is exposed to or irradiated with a first optical signal/radiation, and the metasurface structure is operable to display a second image based on image data embedded or encoded by the sub-wavelength structures when the metasurface structure is exposed to or irradiated with a second optical signal/radiation different from the first optical signal/radiation. The first image includes an optical-printing image and the second image includes one or more holographic images.

### TECHNICAL FIELD

The present invention relates to metasurface structures, related articles and methods for encoding information on the metasurface structures.

### BACKGROUND

Metasurfaces, a new generation of optical devices, allow precise wavefront control at sub-wavelength scale by tailoring the scattering properties (phase, amplitude, polarization, etc.) of constituent meta-atoms [1-3]. Thus, metasurfaces display features unattainable by conventional optical elements, such as the ultra-compactness and multifunctionalities, which can greatly improve the device integration, security and capacity for information encryption [4-8]. In the recent literature, polarization-sensitive meta-atoms were used to create three polarization dependent holographic images by exploiting the full degrees of freedom of Jones matrix of transmission meta-atoms [4, 6]. Malus metasurfaces allow independent amplitude and phase control by combining the rotated identical nano-polarizers with a pair of polarizer and analyzer. It can create one printing image with one [5] or two [7] holographic images, where the polarization multiplexing [9] enabled by propagation phase and Pancharatnam Berry (PB) phase has been adopted in the latter case. The coherent pixel design [10-11] can also achieve complete independent amplitude and phase control by deliberately tailoring the interference between multiple meta-atoms in one super-pixel.

The information community has an increasing interest in diversifying the information storage and augmenting the security and capacity of the encrypted information. Metasurfaces have significant applications in image display and storage applications by virtue of its sub-wavelength pixels and its precise regulation of visible light. Printing images and holographic images are the mostly studied images displayed by metasurfaces, so that the integration of these two forms is fundamental in metasurface imaging applications [11-13], which requires the independent control of the amplitude and phase of the incident waves. The methods most commonly used in integrating multiple holographic images with a printing image rely on wavelength multiplexing [14-15], coherent pixel design [11], or tailoring the PB phase and propagation phase [2], among which the wavelength multiplexing is a simple yet effective way. Multiple wavelengths are multiplexed by stitching different colored patterns to form a new image [15-16] or by including three independent RGB channels in one super-pixel [11, 17]. However, some limits of the above methods are unavoidable, such as intensity imbalance among different colors due to their differences in transmission efficiency and crosstalk in one multiplexing pixel sensitive to nano-fabrication processes.

### SUMMARY OF THE INVENTION

In a first aspect of the invention, there is provided a metasurface structure comprising a plurality of sub-wavelength structures operable to manipulate optical signal/radiation to which metasurface structure is exposed to or irradiated with. The plurality of sub-wavelength structures is arranged such that the metasurface structure is operable to display a first image based on image data embedded or encoded by the sub-wavelength structures when the metasurface structure is exposed to or irradiated with a first optical signal/radiation, and the metasurface structure is operable to display a second image based on image data embedded or encoded by the sub-wavelength structures when the metasurface structure is exposed to or irradiated with a second optical signal/radiation different from the first optical signal/radiation. The first image includes an optical-printing image and the second image includes one or more holographic images.

In some embodiments, the optical-printing image may include a multi-color image, and each of the one or more holographic images may include a monochromatic image. The optical-printing image can be planar or curved.

In some embodiments, the first optical signal/radiation may include white light, and the second optical signal/radiation may include a laser with a specific combination of wavelength, polarization, spatial angle, and/or focal distance.

In some embodiments, the one or more holographic images may be multiple. The second optical signal/radiation may include lasers with different combinations of the wavelength, polarization, spatial angle, and/or focal distance such that each of the one or more holographic images is displayed when the metasurface structure is exposed to or irradiated with a laser with a respective combination of the wavelength, polarization, spatial angle, and/or focal distance. Respective colors of the one or more holographic images may be different.

In some embodiments, the plurality of sub-wavelength structures may include a plurality of sub-wavelength micro-structures or nano-structures.

In some embodiments, the plurality of sub-wavelength structures may include a plurality of nano-blocks.

In some embodiments, the plurality of nano-blocks is in the form of generally rectangular prisms with height, length and width. The plurality of nano-blocks may include at least one first nano-block with a first size in terms of one or more of height, length or width, and at least one second nano-block with a second size different from the first size in terms of one or more of height, length or width. The at least one first nano-block and the at least one second nano-block may have different optical transmission and/or scattering properties.

In some embodiments, the plurality of nano-blocks may further include at least one third nano-block with a third size different from the first size and the second size in terms of one or more of height, length or width. The at least one first nano-block, the at least one second nano-block, and the at least one third nano-block may have different optical transmission and/or scattering properties.

In some embodiments, the plurality of nano-blocks may further include at least one fourth nano-block with a fourth size different from the first size, the second size and the third size in terms of one or more of height, length or width. The at least one first nano-block, the at least one second nano-block, the at least one third nano-block, and the at least one fourth nano-block may have different optical transmission and/or scattering properties.

Optionally, the at least one first nano-block, the at least one second nano-block, the at least one third nano-block, and the at least one fourth nano-block may be arranged to facilitate transmission of different colored lights. For example, each of the at least one first nano-block, the at least one second nano-block, the at least one third nano-block, and the at least one fourth nano-block is arranged to facilitate transmission of a respective one of: blue light (445-520 nm, e.g., 473 nm), green light (520-565 nm, e.g., 532 nm), red light (625-740 nm, e.g., 633 nm), and yellow light (565-600 nm, e.g., 594 nm).

In some embodiments, the plurality of sub-wavelength structures may be distributed evenly or unevenly.

In some embodiments, the plurality of sub-wavelength structures may be distributed unevenly and correspond to unevenly distributed pixels where multiple kinds of super-pixel regions are defined with the plurality of sub-wavelength structures in different sizes and filling densities.

In some embodiments, the multiple kinds of super-pixel regions may include three super-pixel regions which include an RGB region and two monochromatic regions with different pixel periods.

In some embodiments, the RGB region may include two or more sub-pixels to represent two or more different colors.

In some embodiments, the optical-printing image may be realized by the three super-pixel regions, and the one or more holographic images may be realized by a colored super-pixels and sub-pixels of the regions.

In some embodiments, the plurality of sub-wavelength structures may be arranged in one monolayer.

In some embodiments, the plurality of sub-wavelength structures may have the same orientation or different orientations.

In some embodiments, the optical-printing image can be planar or curved.

In some embodiments, the optical-printing image may be arranged to be displayed on a surface at least partly defined by the metasurface structure.

In some embodiments, each of the holographic images may be arranged to be displayed at a location away from the metasurface structure.

Optionally, one of the holographic images is arranged to be displayed at a first focal distance relative to the metasurface structure and at a first spatial angle relative to the metasurface structure.

Optionally, another one of the holographic images is arranged to be displayed at a location away from the metasurface structure, and optionally, the holographic image may be arranged to be displayed at a second focal distance relative to the metasurface structure and at a second spatial angle relative to the metasurface structure. The second focal distance may be the same as first focal distance. The second spatial angle may be different from first spatial angle.

Optionally, yet another one of the holographic images is arranged to be displayed at a location away from the metasurface structure, and optionally, the holographic image may be arranged to be displayed at a third focal distance relative to the metasurface structure and at a third spatial angle relative to the metasurface structure. The third focal distance may be the same as first and/or second focal distance. The third spatial angle may be different from first and/or second spatial angle.

Optionally, still yet another one of the holographic images is arranged to be displayed at a location away from the metasurface structure, and optionally, the holographic image may be arranged to be displayed at a fourth focal distance relative to the metasurface structure and at a fourth spatial angle relative to the metasurface structure. The fourth focal distance may be the same as first and/or second and/or third focal distance. The fourth spatial angle may be different from first and/or second and/or third spatial angle.

In some embodiments, the plurality of sub-wavelength structures may be made of silicon. The plurality of sub-wavelength structures may be operably coupled with a substrate. For example, the plurality of sub-wavelength structures may be attached to, formed on, or otherwise arranged directly or indirectly on the substrate. The substrate can also be considered as part of the metasurface structure. For example, the substrate can be made of silica.

In a second aspect, there is provided an article (e.g., package, product, etc.) comprising the metasurface structure of the first aspect. Optionally, the optical-printing image contains identification information (e.g., trademark). Optionally, the one or more holographic images contain security and/or authentication information. Optionally, each holographic images contains respective security and/or authentication information.

In a third aspect, there is provided a method for encoding information on a metasurface structure including a plurality of sub-wavelength structures. The method includes designing and arranging the plurality of sub-wavelength structures with different chromatic responses in different regions of an optical-printing image, the different regions representing different colors constituting the optical-printing image, and generating one or more holographic images from the different colored regions of the optical-printing image based on Pancharatnam-Berry (PB) phases of the plurality of sub-wavelength structures. The optical-printing image is displayed when the metasurface structure is exposed to or irradiated with the first optical signal/radiation, and the one or more holographic images are displayed when the metasurface structure is exposed to or irradiated with a second optical signal/radiation different from the first optical signal/radiation.

In some embodiments, the method may further include designing one or more super-pixels regions constructing the optical-printing image based on polarization conversion efficiency (PCE) of the plurality of sub-wavelength structures and spatial distribution of different colors in the optical-printing image. The one or more super-pixels regions may have different morphologies and arrangements of the sub-wavelength structures.

In some embodiments, the optical-printing image may include a multi-color image, and each of the one or more holographic images may include a monochromatic image.

In some embodiments, the first optical signal/radiation may include white light, and the second optical signal/radiation may include a laser with a specific combination of wavelength, polarization, spatial angle, and/or focal distance.

In some embodiments, the one or more holographic images may be multiple, and the second optical signal/radiation may include lasers with different combinations of the wavelength, polarization, spatial angle, and/or focal distance such that each of the one or more holographic images is displayed when the metasurface structure is exposed to or irradiated with a laser with a respective combination of the wavelength, polarization, spatial angle, and/or focal distance. Respective colors of the one or more holographic images may be different.

In some embodiments, the plurality of nanostructures may be in the form of generally rectangular prisms with height, length and width, and designing and arranging the plurality of sub-wavelength structures may include selecting the plurality of sub-wavelength structures including at least one first nanostructure with a first size in terms of one or more of height, length or width, and at least one second nanostructure with a second size different from the first size in terms of one or more of height, length or width.

In some embodiments, the plurality of nanostructures may further include at least one third nanostructure with a third size different from the first size and the second size in terms of one or more of height, length or width.

In some embodiments, designing and arranging the plurality of sub-wavelength structures may include arranging the plurality of sub-wavelength structures to be distributed evenly or unevenly.

In some embodiments, designing and arranging the plurality of sub-wavelength structures may include arranging the plurality of sub-wavelength structures to be distributed unevenly, and the plurality of sub-wavelength structures may correspond to unevenly distributed pixels where multiple kinds of super-pixel regions are defined with the plurality of sub-wavelength structures in different sizes and filling densities.

In some embodiments, the multiple kinds of super-pixel regions may include three super-pixel regions which include an RGB region and two monochromatic regions with different pixel periods.

In some embodiments, the RGB region may include two or more sub-pixels to represent two or more different colors.

In some embodiments, the optical-printing image may be realized by the three super-pixel regions, and the one or more holographic images may be realized by a colored super-pixels and sub-pixels of the regions.

In some embodiments, designing and arranging the plurality of sub-wavelength structures may include arranging the plurality of sub-wavelength structures in one monolayer.

In some embodiments, wherein designing and arranging the plurality of sub-wavelength structures may include arranging the plurality of sub-wavelength structures to have the same orientation or different orientations.

In some embodiments, generating one or more holographic images may include applying an optimized Gerchberg-Saxton (G-S) algorithm to obtain a specific combination of work condition for each of the holographic images such that each holographic image can only be read out with a specific combination of work conditions including wavelength, polarization, spatial angle, and/or focal distance.

Other features and aspects of the invention will become apparent by consideration of the detailed description and accompanying drawings. Any feature(s) described herein in relation to one aspect or embodiment may be combined with any other feature(s) described herein in relation to any other aspect or embodiment as appropriate and applicable.

Terms of degree such that “generally”, “about”, “substantially”, or the like, are used, depending on context, to account for manufacture tolerance, degradation, trend, tendency, imperfect practical condition(s), etc. In one example, when a value is modified by terms of degree, such as “about”, such expression includes the stated value ±15%, ±10%, ±5%, ±2%, or ±1%.

Unless otherwise specified, the terms “connected”, “coupled”, “mounted” or the like, are intended to encompass both direct and indirect connection, coupling, mounting, etc.

### BRIEF DESCRIPTION OF DRAWINGS

Embodiments of the invention will now be described, by way of example, with reference to the accompanying drawings, in which:

FIG. 1a is an example multicolor printing image composed of three regions with different colors, as marked by “1”, “2” and “3” in the image; FIG. 1b is an example geometric structure of a meta-atom according to an embodiment of the invention; and FIG. 1c shows a simulated transmission amplitude of the meta-atoms with different sizes while keeping H=600 nm. Silicon nano-blocks with L×W=80 nm×40 nm, 110 nm×40 nm, 140 nm×40 nm and 160 nm×40 nm are specifically designed for transmission of blue (473 nm), green (532 nm), yellow (594 nm) and red (633 nm) light, respectively.

FIG. 2a shows super-pixels constituting the printing metasurface (Regions “1”, “2”, “3” in FIG. 2a correspond to Regions “1”, “2”, “3” in FIG. 1a); and FIG. 2b shows transmission spectrum of super-pixels filled in Region “1”.

FIG. 3 shows work principle and work condition of each holographic image generated from the printing metasurface in one embodiment.

FIG. 4a shows work principle of the printing metasurface with work condition for readout of holographic information according to one embodiment; FIG. 4b shows a design function of holographic information on the focal plane (f=1000 μm); and FIG. 4c shows simulation results of the holographic information on the focal plane.

FIG. 5 shows an example metasurface structure in one embodiment.

FIG. 6a shows a common method of integrating color printing with holograms, showing the spectral crosstalk and the intensity imbalance among different multiplexed color channels as two main issues to be addressed in such design. FIG. 6b shows a schematic diagram of a metasurface based on unevenly distributed pixels according to an embodiment of the invention. With white light illumination, a colored trademark will be observed atop the metasurface. Circularly polarized monochromatic lasers can fetch the corresponding holographic information from the unevenly distributed pixels, where three kinds of super-pixels with nano-blocks in different sizes and filling densities are exploited.

FIG. 7a shows an example nanostructure with identical pitch period P=300 nm, height H=565 nm, and width w=40 nm, while four different length L combinations; and FIGS. 7b to 7e show a simulated transmission amplitude of the nanostructures with four different lengths (L=80 nm, 110 nm, 140 nm, and 160 nm, respectively).

FIG. 8a shows simulated polarization conversion efficiency curves for three kinds of super-pixels with the size 1.2 μm ×1.2 μm; FIG. 8b is a flowchart of the algorithm to integrate four colored holograms with a color-printing trademark composed of three color regions according to an embodiment of the invention, where A1-A4 are the regions containing monochromatic nano-blocks to generate the monochromatic holographic images H1-H4; and FIG. 8c is a flowchart of the optimized Gerchberg- Saxton algorithm.

FIG. 9 shows experimental results of four monochromatic holograms integrated with a color-printing metasurface: (a) is an optical image of the printing metasurface under white light illumination (the size of this trademark is 360 μm×360 μm); (b) is a diagram of a fabricated device according to an embodiment of the invention; (c) to (f) show monochromatic holographic images under left-handed or right-handed circularly polarized (CP) light at wavelengths of 594 nm (LCP), 633 nm (LCP), 532 nm (RCP), and 473 nm (RCP), respectively (the scale-bar is 80 μm); (g) shows SEM images of the three different regions of the camouflage metasurface (the scale-bar is 200 nm); and (h) shows an example optical setup for observation of the color printing and holographic images according to an embodiment of the invention.

FIG. 10 shows a larger field of view of experimentally observed holographic images in one embodiment.

FIG. 11 shows an example fabrication process for the metasurface structure in one embodiment.

Before any embodiments of the invention are explained in detail, it is to be understood that the invention is not limited in its application to the details of embodiment and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

Ultra-compact metasurfaces have shown great potential in precisely manipulating light fields with sophisticatedly designed subwavelength unit cells and their delicate spatial arrangement. In particular, the independent control of phase and amplitude by such metasurfaces has brought about many remarkable applications, such as the integration of color printings and holograms into a single device for large-capacity and high-security encryption of optical information. However, such integration may suffer from two issues, namely spectral crosstalk and intensity imbalance between multiplexed color channels, resulting in the degradation of image quality or the efficiency disproportion between multi-color channels. To address these two issues, a new design concept called “unevenly distributed pixels” (UEDP) is presented to minimize the spectral crosstalk and balance the transmission intensity among colored holographic images. It is shown that the UEDP-based metasurfaces not only enhance the holographic imaging quality but also offer a camouflage method to hide encrypted holographic information in the different constituents of a multicolor printing image. This principle of meta-atom design demonstrates itself as an easy-to-implement and effective means to encode a camouflage metasurface with high-capacity and high-security encrypted holographic information, thus paving the way for combining and improving both the camouflage and encryption functionalities in single metasurface devices.

The following description provides example implementations of the invention as broadly described above.

There is provided multi-channel encrypted holographic information camouflaged by a multi-color printing metasurface.

### First Embodiment

One embodiment of the invention relates to a camouflage method of encrypted holographic information based on a multi-color printing metasurface, i.e., the encrypted information is encoded into different monochromatic holographic images recorded by different constituents of a single printing metasurface. In one example the multicolor printing metasurface that directly displays an image (e.g., a disguised trademark) under white light illumination is used for camouflage, and the holographic ciphertext can only be converted into plaintext at the specific wavelength, polarization, focal length, and/or spatial angle. The technology combines both camouflage and encryption functionalities with one single layer metasurface for improved security and capacity. Uniquely, as a new generation of optical devices, metasurface enables precise wavefront control at deep sub-wavelength scale by tailoring the scattering properties of constituent meta-atoms. Thus, metasurfaces display features unattainable by conventional optical elements, such as ultra-compactness and multifunctionalities, which can greatly improve the security, device integration and information capacity for encryption.

One embodiment of the invention aims to optimize the encryption capacity by fully exploiting the degrees of freedom of each constituent meta-atom forming the printing metasurface as compared with previous research. The disclosed design method includes two steps: First, multicolor printing, as the camouflage technique, is realized by different meta-atoms of the metasurface for high security. Second, encrypted holographic images are designed and recorded by different constituents in the printing metasurface for advanced optical information processing and encryption. Overall, this embodiment proposes a highly restricted access of manifold information, which is very promising for cryptography-related applications, such as anti-counterfeit packaging.

In this disclosed scheme of encryption, both the color printing and the holography are realized by one single metasurface, that is, the faked pattern is printed by the predesigned metasurface under the normal white light incidence for camouflage, and the holographic messages, recorded by the same metasurface can only be recovered with customized keys, including the polarization, working wavelength, focal length and spatial angle of imaging. As a result, the design approach can be technically divided into two steps:

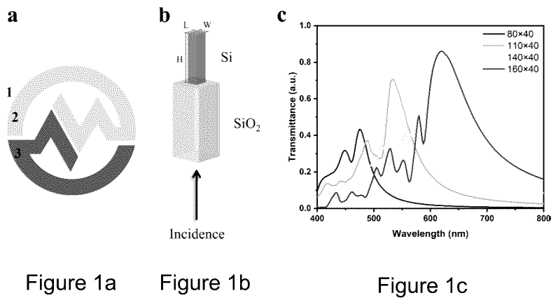

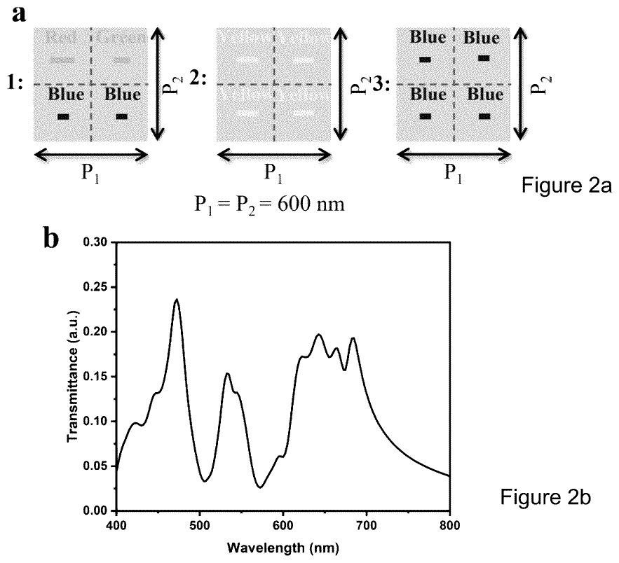

First, as shown in FIGS. 1a to 1c, the multicolor printing image (see FIG. 1a) is realized by elaborately designing and arranging unit cells (see FIG. 1b) with different transmission response under white light illumination (see FIG. 1c) in different regions of the printing metasurface. Specifically, super-pixels with identical pitch period 600 nm and H=600 nm while four different L×W values are used in this design. FIGS. 1a to 1c show a design of a printing metasurface for camouflage in one embodiment. FIG. 1a is an example multicolor printing image composed of three regions with different colors, as marked by “1”, “2” and “3” in the image. FIG. 1b is an example geometric structure of a meta-atom according to an embodiment of the invention. FIG. 1c shows a simulated transmission amplitude of the meta-atoms with different sizes while keeping H=600 nm. Silicon nano-blocks with L×W=80 nm×40 nm, 110 nm×40 nm, 140 nm×40 nm, and 160 nm×40 nm are specifically designed for transmission of blue (473 nm), green (532 nm), yellow (594 nm), and red (633 nm) light, respectively. As shown in FIGS. 2a and 2b, the super-pixel composed of two 80 nm×40 nm, one 110 nm×40 nm, and one 160 nm×40 nm, whose transmission spectrum is shown in FIG. 2b, is filled in Region “1”, in accordance with color mixing theory; the super-pixel composed of four identical nano-blocks with 80 nm×40 nm (L×W) is filled in Region “3” and the super-pixel composed of four identical nano-blocks with 140 nm×40 nm (L×W) is filled in Region “2”. The metasurface based multicolor printing image is thus realized.

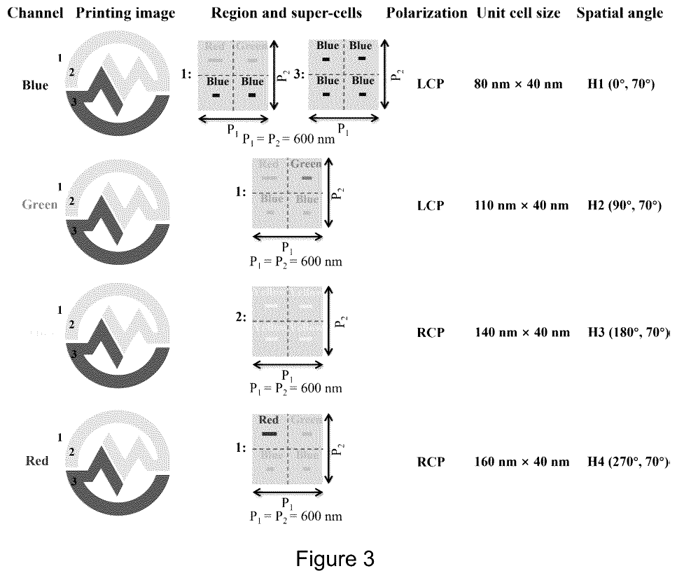

Second, in one example, a Pancharatnam-Berry (PB) phase metasurface is used here for its high manipulation efficiency, precise control of the phase profile and alleviation of the fabrication complexity. The PB phase metasurface achieves the phase control of cross-circularly polarized waves by simply manipulating the in-plane orientations of nano-blocks. Especially, by applying the optimized Gerchberg-Saxton (G-S) algorithm, the phase distribution needed to generate holographic images at different work conditions can be freely obtained, which determines also the distribution of different super-pixels. The work conditions for holographic image display at blue (473 nm), green (532 nm), yellow (594 nm) and red (633 nm) are given in FIG. 3. The multiple holographic images realized at different wavelengths will not interfere with each other and thus ensure their color purity. Besides, each camouflaged holographic information can only be correctly read out with specific a combination of work conditions such as the wavelength, polarization of incident waves, observation distance (equals to focal distance), and spatial angle, thus ensuring the high encryption security. Overall, one single multicolor metasurface can not only conceal the valuable encrypted information with disguises but also be deciphered into multiple messages with predesigned keys, improving both the data capacity and the information security.

### Example Features

There is provided a camouflage method by encoding holographic images into a multicolor printing metasurface. In one example, unit cells with different combinations of length and width are responsible for high transmission at blue (473 nm), green (532 nm), yellow (594 nm) and red (633 nm). In one example, super-pixels composed of different combinations of unit cells are responsible for the multicolor printing, in accordance with color mixing theory. In one example, the encoded holographic images at different wavelengths are generated by unit cells with different combinations of length and width. In one example, correct holographic information can only be read out with correct keys, including the wavelength, optical polarization, focal distance and spatial angle. In one example, one multicolor printing image for camouflage with four encrypted monochromatic holographic images is realized.

### Example Functions and Applications

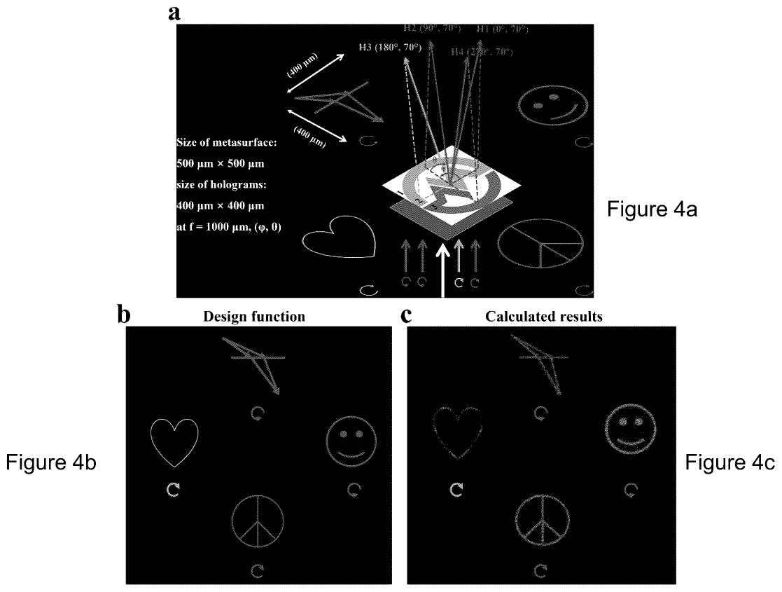

FIGS. 4a to 4c show a scheme of encrypted holographic information camouflaged by the printing metasurface in one embodiment. FIG. 4a shows work principle of the printing metasurface with work condition for readout of holographic information. FIG. 4b shows a design function of holographic information on the focal plane (f=1000 μm). FIG. 4c shows simulation results of the holographic information on the focal plane.

When white light impinges upon the metasurface, the multicolor printing image will appear, as shown in FIG. 1a and in FIG. 4a. However, only when light at a specific wavelength strikes the metasurface, correct holographic information can be read out. For example, when waves at 473 nm with left-handed circular polarization (LCP) strike the metasurface, a “smiley face” will be formed at f=1000 μm and spatial angle (azimuthal angle, elevation angle)=(0°,70°). In a similar way, the holographic images formed by green light (represents “generalized Snell's law”), yellow light (represents “love”) and red light (represents “peace”) can also be formed under work conditions as illustrated in FIG. 3. The desired patterns on the focal plane (f=1000 μm) are plotted in FIG. 4b and the simulation results produced by the metasurface with a phase profile generated by the optimized Gerchberg-Saxton (G-S) algorithm are shown in FIG. 4c. The simulation agrees well with the disclosed design function.

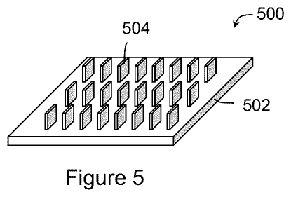

FIG. 5 shows an example metasurface structure incorporating the above design example. FIG. 5 is used to illustrate an example overall structure, and it is not drawn to scale and it does not show the different sizes/orientations/configurations of the metasurface elements. As shown in FIG. 5, the metasurface structure 500 includes a substrate 502 (e.g., silica) and a plurality of sub-wavelength structures 504 (e.g., silicon, 24 pieces shown in FIG. 5) operable to manipulate optical signal/radiation to which metasurface structure is exposed to or irradiated with. The plurality of sub-wavelength structures is arranged such that: the metasurface structure is operable to display an optical-printing image based on image data embedded or encoded by the sub-wavelength structures when the metasurface structure is exposed to or irradiated with a first optical signal/radiation (e.g., white light), and the metasurface structure is operable to display one or more holographic images based on image data embedded or encoded by the sub-wavelength structures when the metasurface structure is exposed to or irradiated with a respective further optical signals/radiations different from the first optical signal/radiation. The plurality of sub-wavelength structures includes a plurality of sub-wavelength micro-structures or sub-wavelength nano-structures. Each of the plurality of sub-wavelength structures can be shaped as a prism, cylinder, etc. Preferably, each of the plurality of sub-wavelength structures can be shaped as a rectangular prism. The plurality of sub-wavelength structures can be arranged in at least two different shapes, at least two different sizes (for example, one or more of height, length, and width when the sub-wavelength structure is shaped as a rectangular prism), and/or at least two different orientations.

### Example Advantages

In terms of encryption devices, compared with conventional optical elements, metasurfaces, as the new generation optical device, show great potential in precisely manipulating multiple parameters of light waves with ultracompact thickness, significantly improving information storage density [35] and the complexity of encryption keys [36-37]. In the recent literature, optical polarization has been proposed to realize polarization sensitive encrypted holographic images [5, 8]. However, only one encrypted holographic image was demonstrated. A document [10] discloses a “coherent pixel design” method to enrich the printing images with only two holographic images. In a document [11], one single full-color printing image with one single full-color hologram has been demonstrated using the interference between adjacent unit cells. However, this work has under-evaluated the encryption capacity of holographic metasurfaces. Overall, the disclosed design approach has investigated the possibility to integrate functionalities of multicolor printing for camouflage and manifold encryption of holographic images. This disclosed design demonstrated a compact data storage system/method with high-level information security.

### Second Embodiment

Another embodiment of the invention provides a camouflage method of encrypted holographic information hidden in a multicolor printing metasurface based on unevenly distributed pixels, that is, the encrypted information, namely the different monochromatic holographic images, are recorded by different constituents of the printing metasurface. The metasurface directly displaying an image (e.g., trademark) under white light illumination is used for camouflage, and the holographic ciphertext can only be converted into plaintext when optically excited with a specific combination of monochromatic wavelength and polarization, which can only be read out on a definite observation plane at a specific spatial angle. Thus, the proposed design principle based on unevenly distributed pixels demonstrates itself a simple yet efficient way to encode a camouflage metasurface with high-capacity and high-security encrypted holographic information, thus paving the way for combining and improving both the camouflage and the encryption functionalities in one monolayer metasurface device.

Metasurfaces, a new class of optical devices, allow precise control of light-field at the subwavelength scale [38-43] by tailoring the resonance properties (geometric phase, structural birefringent, etc.) of constituent meta-atoms [1-3]. The decoupling of degrees of freedom (DoF) in light-field control, especially the independent control of amplitude and phase (A-P), has enabled plethora of novel applications [11, 44-47]. For example, the A-P independent control allows the integration of printing and holographic imaging [14, 16, 48], which has been widely exploited for high-capacity information storage and high-security encryption [4-8]. At present, several efficient methods have been developed to integrate multiple holographic images with a single printing image, including wavelength multiplexing [14-15], coherent pixel design [11], and simultaneous tailoring of the Pancharatnam-Berry (PB) phase and propagation phase [2]. Among them, the wavelength multiplexing method is the most universal and can be multiplexed in two ways, that is, stitching different colored patterns to form a new colored printing image where each colored pattern produces a monochromatic holographic image [15-16], and independently adjusting the RGB (i.e., red, green, and blue) of super-pixels where each colored sub-pixel generates a monochromatic holographic image [11, 17].

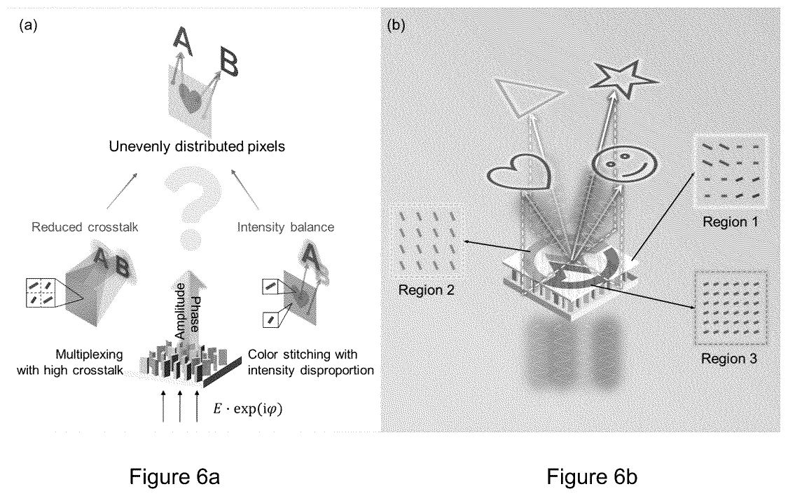

Despite recent advances, the spectral crosstalk between different color channels and the intensity imbalance among different colored patterns are two major concerns when evaluating the quality of image integration. As shown in FIG. 6a, the former effect is associated with the resonance spectral overlap of wavelength-multiplexed pixels induced by nano-fabrication errors, and the latter is caused by the imbalanced transmission efficiencies of different colored patterns. Therefore, minimizing the spectral crosstalk between multiplexing pixels and balancing the transmission efficiencies of adjacent colored patterns could significantly improve the integration quality of printing and holographic images.

This embodiment of the invention provides the concept of “unevenly distributed pixels” (UEDP) consisting of meta-atoms with varied sizes and spatial arrangement to address the above-mentioned issues. It is shown that a UEDP-based silicon metasurface can integrate four independent holographic images with one colored printing image, with balanced image intensity and lower spectral crosstalk among different color channels. This also enables the camouflage function that the color printing under white light illumination serves as interference information with the ciphertext of four holographic images to be read out at different observation planes and viewing angles away from the printing image. The proposed embodiment demonstrates highly restricted access to manifold information, which is very promising for cryptography-related applications, such as information multiplexing, encryption and anti-counterfeit packaging.

### Methods

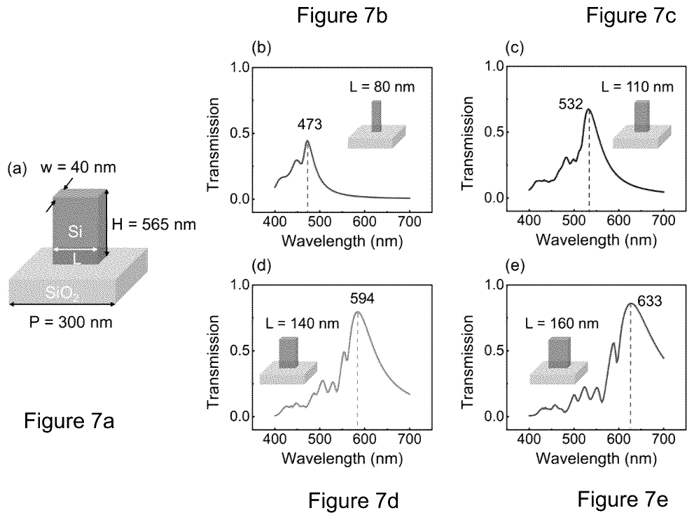

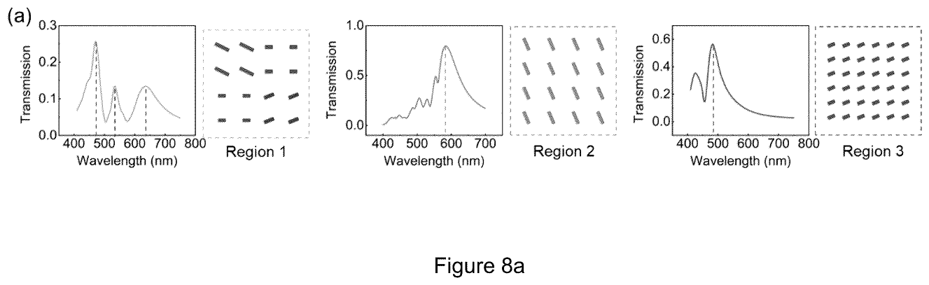

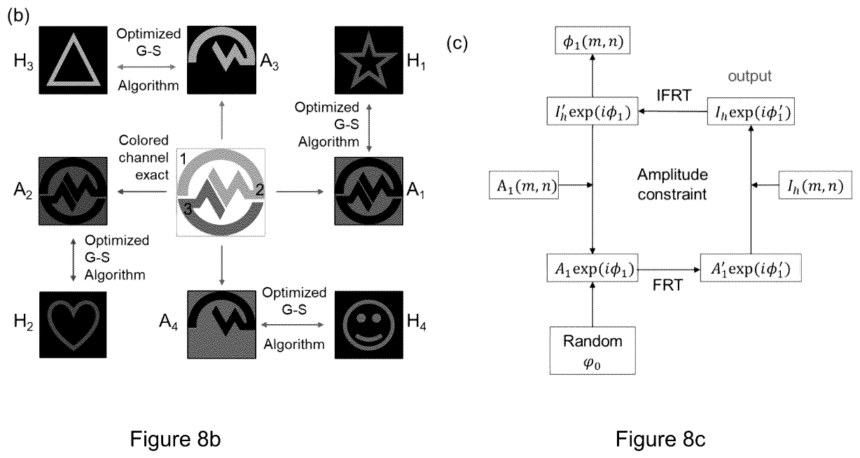

Camouflage information is purposely designed to confuse the public in order to enhance the security of encrypted true information. To this end, it is important that camouflage information and true information are stored in different manners with different decryption difficulties [8, 10-11, 18]. As a scheme of encryption in the proposed design, both the color printing and the holography are realized by one single metasurface, that is, the faked pattern is printed by the prescribed metasurface under the normal white light incidence for camouflage, and the holographic messages, recorded by the same metasurface can only be recovered with customized keys, including the polarization, working wavelength, focal length and spatial angle of imaging. The design of the above device is divided into three steps: First, design the dimensions of nano-blocks with different chromatic response under white light illumination; Second, tune the filling factors of nano-blocks to balance their conversion efficiency in order to fill them in different regions and thus form the printing image (shown in FIG. 8a); Third, calculate the PB phase of each nano-block according to the four holograms by using an optimized Gerchberg-Saxton (G-S) algorithm (FIGS. 8b and 8c). Thus, the multicolor printing image (FIG. 6b) is formed by elaborately tailoring the dimensions and filling densities of nano-blocks displaying different transmission spectra under white light illumination (FIGS. 7a to 7e) and then carefully arranging them in different regions in the printing metasurface (see the three regions in FIG. 6b). This structural color design approach can be provided by using either plasmonic [19-23] or high-index dielectric [11, 24-29] nanostructures. The encrypted holographic images are then constructed by the rotated nano-blocks according to the PB phase calculated by the G-S algorithm.

Detailed description on the design of the proposed device according to this embodiment is provided. FIGS. 7a to 7e show simulated polarization conversion efficiency curves for silicon nano-block arrays of four different lengths on a silica substrate, corresponding to four structural colors. The pitch period is 300 nm for all four cases. FIG. 7a shows an example nanostructure with identical pitch period P=300 nm, height H=565 nm, and width w=40 nm, while four different length L combinations. FIGS. 7b to 7e show simulated transmission amplitude of the nanostructures with different lengths (L=80 nm. 110 nm, 140 nm, and 160 nm, respectively). FIGS. 8a to 8c show a design concept of the metasurface for integration of four holograms with one color-printing trademark according to an embodiment of the invention. FIG. 8a shows simulated polarization conversion efficiency curves for three kinds of super-pixels with the size 1.2 μm×1.2 μm. FIG. 8b is a flowchart of the algorithm to integrate four colored holograms with a color-printing trademark composed of three color regions according to an embodiment of the invention, where A1-A4 are the regions containing monochromatic nano-blocks to generate the monochromatic holographic images H1-H4. FIG. 8c is a flowchart of the optimized Gerchberg-Saxton algorithm.

Concept of unevenly distributed pixels. The transmission spectra overlap between different sized meta-atoms in a super-pixel result in spectral crosstalk that is produced by interference between different color channels. Fabrication errors may worsen this problem. Consequently, a specific color channel could generate diffuse spots from other holograms except the predesigned one, which will significantly restrict the quantity and quality of the encrypted information. Additionally, the total channel intensity of each color will be affected by the area proportion and the transmission efficiency of different meta-atoms in the color stitching printing image. Different colored channels may vary in brightness (see the right of FIG. 6a), which could lead to difficulties in observing holographic images in various colors.

Considering the pros and cons of the two methods, this embodiment of the invention proposes a new solution named “unevenly distributed pixels” (UEDP) to circumvent the issues of spectral crosstalk and intensity imbalance in hologram-printing integration. The super-pixels of the UEDP-based metasurface consist of meta-atoms varying in size and arrangement, as shown in the “Regions 1-3” in FIG. 6b. Region 1 is filled by RGB super-pixels to support three color channels simultaneously, while Regions 2 and 3 are monochromatic (yellow and blue) with meta-atoms in specially-chosen sizes and periods. These three regions make up a color-printing image at the structural plane of the metasurface and support four color channels in total.

The spectral crosstalk and intensity imbalance are optimized by utilizing UEDP in two ways. First, to reduce the spectral crosstalk, the proposed embodiment optimizes the size selection of meta-atoms in each region (referring to FIGS. 7a to 7e), which minimizes the transmission spectral overlap of nano-blocks in different sizes. Furthermore, designing holographic images at various observation planes and spatial observation angles can further reduce the spatial interference between different holographic channels induced by spectral crosstalk. Regarding intensity imbalance, the combination of monochromatic and RGB pixels can adaptively address this issue. For instance, silicon experiences significant loss in the blue band, requiring a compensation by enlarging the blue region area. This is achieved by utilizing the blue pattern of Region 3 together with the blue sub-pixels in Region 1 to contribute to the blue hologram.

The proposed metasurface features two main functionalities. Firstly, the multicolor printing serves as camouflage and exhibits a trademark under white light illumination. This is achieved through various meta-atoms forming three colored regions for heightened security. Secondly, encrypted information is written in four holographic images designed and recorded by different constituents in the printing metasurface. The holographic ciphertext can only be converted to plaintext when optically excited by a specific combination of a monochromatic wavelength and polarization. Moreover, it can only be read out on a definite observation plane at a specific spatial angle. Our UEDP-based metasurface can improve information storage and encryption capacities compared to previous research.

Determination of the basic structural size of meta-atoms. Before designing a functional metasurface device, it is necessary to identify suitable structural sizes of meta-atoms that correspond to the target color channels. This serves as the foundational basis for obtaining nanostructures with photonic resonance modes situated at the specific design wavelengths.

The proposed embodiment uses the polarization conversion efficiency (PCE) of circularly polarized (CP) light which is orthogonal between incident and output waves based on the principle of the PB phase. Previous research has shown that the resonance wavelength of a nano-block increases with the length if the period, width, and height

remain constant [11]. To prevent near-field coupling resulting from excessive proximity between nano-blocks, the selected period should be as minimal as possible to guarantee the maximum interaction area between light and matter and, thus, assure heightened efficiency. After thorough evaluation, the period of a single nano-block at 300 nm (see FIG. 7a) is established. The length-to-width ratio of a rectangular nano-block influences its birefringence, and increased width causes the transmission peaks to broaden and split. A nano-block's transmission peak becomes higher and narrower as its height increases. To account for the challenges of practical manufacturing, in an embodiment, it has been determined that the nano-blocks' width and height should be uniform, at 40 nm and 565 nm, respectively (refer to FIG. 7a). By employing four lengths of 80 nm, 110 nm, 140 nm, and 160 nm, the nano-blocks' transmission peaks can be located at four design wavelengths (473 nm, 532 nm, 594 nm, and 633 nm), as illustrated in FIGS. 7b to 7e.

Design of the camouflage metasurface. Camouflage information is intentionally created to increase the security of encrypted true information by intentionally confusing the public. Therefore, it is crucial to store camouflage information and true information differently, with varying decryption difficulties [8, 10-11, 18]. As part of the proposed encryption design, a single metasurface is utilized to achieve both color printing and holography. Specifically, the metasurface is used to print a fake pattern under normal white light for camouflage. Holographic messages are also recorded by the same metasurface but can only be recovered using customized keys that include the polarization, working wavelength, focal length, and spatial angle for imaging.

Based on the structural sizes of nano-blocks depicted in FIGS. 7a to 7e, the peak PCE values show an upward trend with an increase in the length of a nano-block. Therefore, the efficiency of the blue channel is only half of the red. The issue is resolved by employing UEDP with a two-pronged approach: First, increase the nano-block density of the blue region by shortening the period. The length of nano-blocks in the blue region is 80 nm, which is half of those in the red region. A shorter length means a smaller period is tolerable because of less near-field coupling between adjacent nano-blocks. Besides, the blue channel in the RGB region of the printing image contributes to the hologram together with the blue region. Another option is to enlarge the blue channel by utilizing the blue sub-pixel within the white region in conjunction with the blue region in order to enhance the intensity.

As a result, three kinds of regions are obtained in the metasurface. The demonstration and transmission spectra of the three kinds of super-pixels constructing the three regions of the metasurface are shown in FIG. 8a. The size of a super-pixel in FIG. 8a is 1.2 μm×1.2 μm; the period of the nano-blocks in Regions 1 and 2 is 300 nm, which is 200 nm for Region 3. Region 1 offers red, green, and blue channels simultaneously and presents a white color. Regions 2 and 3 are monochromatic, presenting yellow and blue, respectively. The above three regions make up the color printing image of the metasurface under white illumination, with balanced intensities for four colored channels as shown in the center of FIG. 8b.

The final step to design the camouflage metasurface involves writing in the ciphertext message, which integrates four holographic images into three colored regions. To calculate the PB phase of nano-blocks of each colored channel, a set of processes based on the optimized Gerchberg-Saxton (G-S) algorithm is employed. The four monochromatic color channels (named A1-A4) containing different colored meta-atoms are extracted from the three colored regions of the printing trademark, with corresponding target monochromatic holographic images marked as H1-H4 in FIG. 8b. Then, the rotation of nano-blocks in each pixel of the metasurface is determined by calculating H1-H4 from A1-A4 using the optimized G-S algorithm shown in FIG. 8c.

In other words, four holographic images are generated from the different colored regions of the printing metasurface. A Pancharatnam-Berry (PB) phase metasurface is used here for its high manipulation efficiency, precise control of the phase profile, and alleviation of the fabrication complexity [30-31]. The PB phase metasurface achieves the phase control of cross-circularly polarized waves by simply manipulating the in-plane orientations of nano-blocks. Especially, by applying the optimized Gerchberg-Saxton (G-S) algorithm, the phase distribution required to generate monochromatic holographic images at a specific work condition can be readily obtained, which determines the orientation of each sub-pixel, thus forming the super-pixels and the regions. As shown in FIG. 8b, the areas containing monochromatic nano-blocks (referred to as A1-A4) are extracted from the ensemble of the printing trademark (as shown in the center) and their corresponding target monochromatic holographic images are marked as H1-H4. It can be seen that A1 and A2 are respectively composed by the red and green sub-pixels in Region 1. A3 is merely composed by the yellow super-pixels, and A4 is composed by both the super-pixels in Region 3 and the blue sub-pixels in Region 1. This arrangement of super-pixels and sub-pixels for generating monochromatic holographic images is referred to as the unevenly distributed pixels. Then the rotation of nano-blocks in each pixel of the metasurface is obtained by calculating H1-H4 from A1-A4 in FIG. 8b using the optimized G-S algorithm (as shown in FIG. 8c).

Considering the spatial distribution of holography, the proposed design purposely set the foci 800 μm, 1200 μm, 1600 μm, and 2000 μm for blue (473 nm), green (532 nm), yellow (594 nm), and red (633 nm) light illumination, with spatial angles (azimuthal angle, elevation angle) of (−90°, 70°), (0°, 70°), (90°, 70°), and (180°, 70°), respectively. In this way, the multiple holographic images realized at different wavelengths will not interfere with each other and thus ensure their color purity. Additionally, the chirality of the illumination light is left-handed circular polarization (LCP) for yellow and red incident light and right-handed circular polarization (RCP) for blue and green incident light. Consequently, camouflaged holographic information can only be correctly read out with a specific combination of work conditions such as the wavelength, polarization of incident waves, observation distance (equals to focal distance), and spatial angle (viewing angle), thus ensuring high encryption security. As a result, one single multicolor metasurface can not only conceal the valuable encrypted information with disguises but also be deciphered into multiple messages with predesigned keys, thereby improving both the data capacity and the information security.

Experimental Results

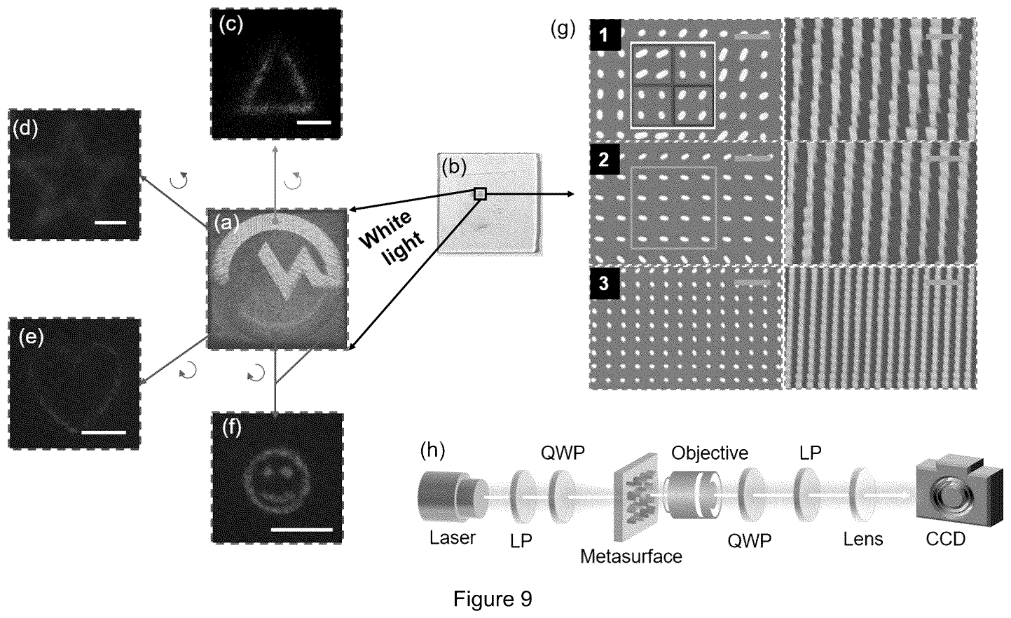

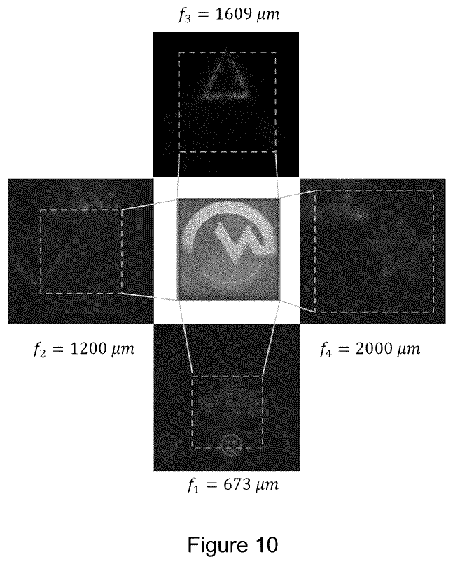

FIGS. 9a to 9h show experimental results of four monochromatic holograms integrated with a color-printing metasurface. FIG. 9a is an optical image of the printing metasurface under white light illumination (the size of this trademark is 360 μm×360 μm). FIG. 9b is a diagram of a fabricated device according to an embodiment of the invention. FIGS. 9c to 9f show monochromatic holographic images under left-handed or right-handed circularly polarized (CP) light at wavelengths of 633 nm (LCP), 532 nm (RCP), 594 nm (LCP), and 473 nm (RCP), respectively (the scale-bar is 80 μm). FIG. 9g shows SEM images of the three different regions of the camouflage metasurface (the scale-bar is 200 nm). FIG. 9h shows an example optical setup for observation of the color printing and holographic images according to an embodiment of the invention. A printing image is observed under incident-output orthometric CP white light as shown in FIG. 9a, and four monochromatic holographic images are captured by a CCD camera at different distances from the metasurface under CP laser illuminations as shown in FIGS. 9c. 9d, 9e, and 9f. It is worth noting that the relationship between the sizes of the printing image and the holographic image can be determined by the formula

$$L = \frac{N}{{L}_{0}} λ f ,$$

where N/L₀ is the reciprocal of the pixel size of the printing image, and L is the measured size of a holographic image. As a result, the measured size of a holographic image is proportional to the product of wavelength λ and focal distance f. A larger field of view of the experimental observation is given in FIG. 10, demonstrating the good spatial separation and color purity of the four holographic images. With the light redshifted, both the wavelength and focus increase, producing larger holographic images, as confirmed by FIG. 10.

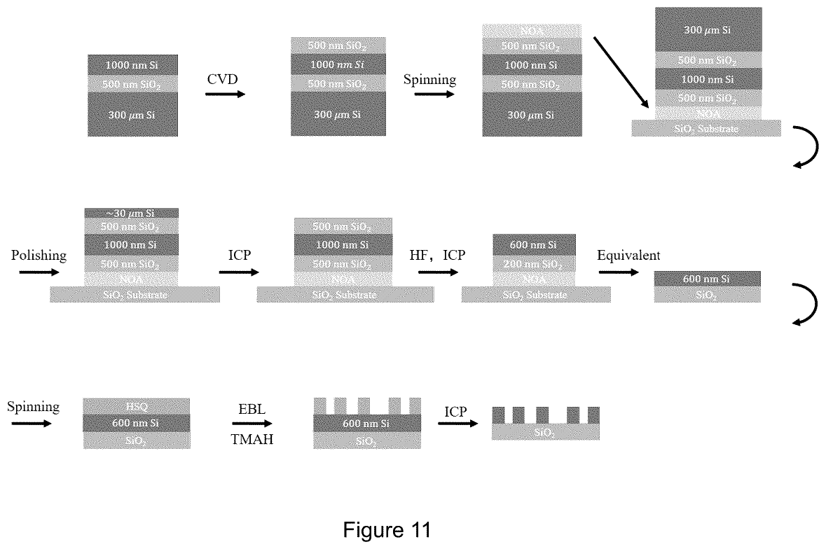

The nanofabrication process involves four main steps: transfer and polish of the crystalline silicon layer, electron beam lithography and resist development, and inductively coupled plasma (ICP) etching, to transfer the pattern to the crystalline silicon layer [13]. The flowchart of the fabrication process is given in FIG. 11. The final metasurface device was fabricated on a 2 cm×2 cm quartz substrate, with a central sample area of 360 μm× 360 μm (see the diagram in FIG. 9b). The sample is nearly transparent to the naked eye, and the nanostructures in Regions 1-3 (FIG. 9g) are characterized by scanning electron microscopy (SEM).

The performance of the camouflage metasurface is characterized by using the optical setup shown in FIG. 9h. A laser generates plane waves at the beginning of the light path, passing through a linear polarizer (LP) and a quarter-wave plate (QWP). The transmitted light is thus turned into a CP state and incident on the metasurface device. A 10×objective collects the signal modulated by the metasurface, and the following QWP and LP filter orthogonally polarized component within the output signal. Finally, the image on the focal plane of the objective is projected by a lens to the CCD camera.

This embodiment of the invention provides a camouflage design approach for multi-channel holographic information encryption camouflaged by a multicolor printing metasurface with pixels distributed unevenly to minimize spectral crosstalk and color intensity imbalance. The proposed design approach is demonstrated with both simulation and experimental results, verifying that independent holographic images can be encrypted into each color region in the printed metasurface, and they can only be read out with specific combinations of wavelength, polarization, spatial angle, and observation distance. Silicon nano-blocks displaying different structural colors are used to form the printed metasurface and the PB phase of each nano-block is used to realize the encrypted holographic images. The experimental results agree well with the proposed design functionalities. Thus, the proposed design approach has successfully validated the possibility of integration of compact data with high-capacity and high-level information security into a camouflage object. It should be noted that, with future advanced electron beam lithography [32-33] or optical lithography [34] driving flat optics from lab to fab, the proposed design approach can be promisingly used to realize mm or even cm scale multicolor printed trademarks with more enriched encrypted information for practical applications. Thus, the proposed printed camouflage metasurface will find itself an indispensable place in information encryption, anti-counterfeiting packaging, etc.

It will be appreciated by a person skilled in the art that variations and/or modifications may be made to the described and/or illustrated embodiments of the invention to provide other embodiments of the invention. The described/or illustrated embodiments of the invention should therefore be considered in all respects as illustrative, not restrictive. Example optional features of some embodiments of the invention are provided in the summary and the description. Some embodiments of the invention may include one or more of these optional features (some of which are not specifically illustrated in the drawings). Some embodiments of the invention may lack one or more of these optional features (some of which are not specifically illustrated in the drawings). While some embodiments relate to human point clouds, it should be appreciated that methods/framework of the invention can be applied to other point clouds (not limited to human point clouds).

### REFERENCES

ADDIN EN.REFLIST [1] N. Yu, P. Genevet, M. A. Kats, F. Aieta, J.-P. Tetienne, F. Capasso, Z. Gaburro, Science 2011, 334, 333.
[2] A. C. Overvig, S. Shrestha, S. C. Malek, M. Lu, A. Stein, C. Zheng, N. Yu, Light: Science & Applications 2019, 8, 92.
[3] M. Liu, W. Zhu, P. Huo, L. Feng, M. Song, C. Zhang, L. Chen, H. J. Lezec, Y. Lu, A. Agrawal, T. Xu, Light: Science & Applications 2021, 10, 107.
[4] R. Zhao, B. Sain, Q. Wei, C. Tang, X. Li, T. Weiss, L. Huang, Y. Wang, T. Zentgraf, Light: Science & Applications 2018, 7, 95.
[5] L. Deng, J. Deng, Z. Guan, J. Tao, Y. Chen, Y. Yang, D. Zhang, J. Tang, Z. Li, Z. Li, S. Yu, G. Zheng, H. Xu, C.-W. Qiu, S. Zhang, Light: Science & Applications 2020, 9, 101.
[6] Y. Hu, L. Li, Y. Wang, M. Meng, L. Jin, X. Luo, Y. Chen, X. Li, S. Xiao, H. Wang, Y. Luo, C.-W. Qiu, H. Duan, Nano Letters 2020, 20, 994.
[7] Z. Li, C. Chen, Z. Guan, J. Tao, S. Chang, Q. Dai, Y. Xiao, Y. Cui, Y. Wang, S. Yu, G. Zheng, S. Zhang, Laser & Photonics Reviews 2020, 14, 2000032.
[8] J. Deng, Z. Li, J. Li, Z. Zhou, F. Gao, C. Qiu, B. Yan, Advanced Optical Materials 2022, 10, 2200949.
[9] J. P. Balthasar Mueller, N. A. Rubin, R. C. Devlin, B. Groever, F. Capasso, Physical Review Letters 2017, 118, 113901.
[10] Y. Bao, Y. Yu, H. Xu, Q. Lin, Y. Wang, J. Li, Z.-K. Zhou, X.-H. Wang, Advanced Functional Materials 2018, 28, 1805306.
[11] Y. Bao, Y. Yu, H. Xu, C. Guo, J. Li, S. Sun, Z.-K. Zhou, C.-W. Qiu, X.-H. Wang, Light: Science & Applications 2019, 8, 95.
[12] S. Wan, C. Wan, C. Dai, Z. Li, J. Tang, G. Zheng, Z. Li, Advanced Optical Materials 2021, 9.
[13] Y. Q. Zheng, Y. H. Deng, Z. H. Shi, Y. L. Fan, Z. C. Wang, D. Y. Lei, Z. K. Zhou, X. H. Wang, Advanced Materials Technologies 2023, 8, 2201468.
[14] Y. Hu, X. Luo, Y. Chen, Q. Liu, X. Li, Y. Wang, N. Liu, H. Duan, Light Sci Appl 2019, 8,86.
[15] Q. Wei, B. Sain, Y. Wang, B. Reineke, X. Li, L. Huang, T. Zentgraf, Nano Lett. 2019, 19, 8964.
[16] D. Wen, J. J. Cadusch, J. Meng, K. B. Crozier, Advanced Functional Materials 2019, 30, 1906415.
[17] W. Zhao, B. Liu, H. Jiang, J. Song, Y. Pei, Y. Jiang, Opt. Lett. 2016, 41, 147.
[18] J. Xue, Z.-K. Zhou, L. Lin, C. Guo, S. Sun, D. Lei, C.-W. Qiu, X.-H. Wang, Light: Science & Applications 2019, 8, 101.
[19] K. Kumar, H. Duan, R. S. Hegde, S. C. W. Koh, J. N. Wei, J. K. W. Yang, Nature Nanotechnology 2012, 7, 557.
[20] S. J. Tan, L. Zhang, D. Zhu, X. M. Goh, Y. M. Wang, K. Kumar, C.-W. Qiu, J. K. W. Yang, Nano Letters 2014, 14, 4023.
[21] A. Kristensen, J. K. W. Yang, S. I. Bozhevolnyi, S. Link, P. Nordlander, N. J. Halas, N. A. Mortensen, Nature Reviews Materials 2016, 2, 16088.
[22] H. Wang, X. Wang, C. Yan, H. Zhao, J. Zhang, C. Santschi, O. J. F. Martin, ACS Nano 2017, 11, 4419.
[23] L. Shao, X. Zhuo, J. Wang, Advanced Materials 2018, 30, 1704338.
[24] J. Proust, F. Bedu, B. Gallas, I. Ozerov, N. Bonod, ACS Nano 2016, 10, 7761.
[25] S. Sun, Z. Zhou, C. Zhang, Y. Gao, Z. Duan, S. Xiao, Q. Song, ACS Nano 2017, 11, 4445.
[26] B. Yang, W. Liu, Z. Li, H. Cheng, D.-Y. Choi, S. Chen, J. Tian, Nano Letters 2019, 19, 4221.
[27] W. Yang, S. Xiao, Q. Song, Y. Liu, Y. Wu, S. Wang, J. Yu, J. Han, D.-P. Tsai, Nature Communications 2020, 11, 1864.
[28] C. Zhang, J. Jing, Y. Wu, Y. Fan, W. Yang, S. Wang, Q. Song, S. Xiao, ACS Nano 2020, 14, 1418.
[29] J. Jing, Y. C. Yiu, C. Chen, D. Lei, L. Shao, Q. Wang, K. H. Li, N. Wong, Z. Chu, Advanced Photonics Research 2022, 3, 2100292.
[30] D. Lin, P. Fan, E. Hasman, M. L. Brongersma, Science 2014, 345, 298.
[31] G. Zheng, H. Mühlenbernd, M. Kenney, G. Li, T. Zentgraf, S. Zhang, Nature Nanotechnology 2015, 10, 308.
[32] R. J. Lin, V.-C. Su, S. Wang, M. K. Chen, T. L. Chung, Y. H. Chen, H. Y. Kuo, J.-W. Chen, J. Chen, Y.-T. Huang, J.-H. Wang, C. H. Chu, P. C. Wu, T. Li, Z. Wang, S. Zhu, D. P. Tsai, Nature Nanotechnology 2019, 14, 227.
[33] L. Li, Z. Liu, X. Ren, S. Wang, V.-C. Su, M.-K. Chen, C. H. Chu, H. Y. Kuo, B. Liu, W. Zang, G. Guo, L. Zhang, Z. Wang, S. Zhu, D. P. Tsai, Science 2020, 368, 1487.
[34] N. Li, Z. Xu, Y. Dong, T. Hu, Q. Zhong, Y. H. Fu, S. Zhu, N. Singh, 2020, 9, 3071.
[35] Z. H. Jiang et al, A Single Noninterleaved Metasurface for High—Capacity and Flexible Mode Multiplexing of high order Poincare Sphere Beams. Adv. Mater., 32, 1903983 (2020).
[36] S. Li et al, Efficient Optical Angular Momentum Manipulation for Compact Multiplexing and Demultiplexing Using a Dielectric Metasurface. Adv. Optical Mater. 8, 1901666 (2020).
[37] S. Chen et al, Cylindrical vector beam multiplexer/demultiplexer using off-axis polarization control. Light-Sci. Appl. 10, 222 (2021).
[38] Y. F. Yu, A. Y. Zhu, R. Paniagua-Domínguez, Y. H. Fu, B. Luk'yanchuk, A. I. Kuznetsov, Laser Photonics Rev. 2015, 9, 412.
[39] S. Wang, Z. L. Deng, Y. Wang, Q. Zhou, X. Wang, Y. Cao, B. O. Guan, S. Xiao, X. Li, Light Sci Appl 2021, 10, 24.
[40] Y. Ni, C. Chen, S. Wen, X. Xue, L. Sun, Y. Yang, eLight 2022, 2.
[41] R. Zhu, J. Wang, T. Qiu, Y. Han, X. Fu, Y. Shi, X. Liu, T. Liu, Z. Zhang, Z. Chu, C.-W. Qiu, S. Qu, eLight 2022, 2.
[42] Z. Feng, T. Shi, G. Geng, J. Li, Z.-L. Deng, Y. Kivshar, X. Li, eLight 2023, 3.
[43] C. Li, J. Jang, T. Badloe, T. Yang, J. Kim, J. Kim, M. Nguyen, S. A. Maier, J. Rho, H. Ren, I. Aharonovich, eLight 2023, 3.
[44] R. Fu, X. Shan, L. Deng, Q. Dai, Z. Guan, Z. Li, G. Zheng, Opt Express 2021, 29, 27696.
[45] Y. Bao, L. Wen, Q. Chen, C. W. Qiu, B. Li, Sci. Adv. 2021, 7, eabh0365.
[46] H. Ren, X. Fang, J. Jang, J. Burger, J. Rho, S. A. Maier, Nat. Nanotechnol. 2020, 15, 948.
[47] G. Y. Lee, G. Yoon, S. Y. Lee, H. Yun, J. Cho, K. Lee, H. Kim, J. Rho, B. Lee, Nanoscale 2018, 10, 4237.
[48] X. H. Luo, Y. Q. Hu, X. Li, Y. T. Jiang, Y. S. Wang, P. Dai, Q. Liu, Z. W. Shu, H. G. Duan, Adv. Optical Mater. 2020, 8, 1902020.

1. A metasurface structure comprising:
a plurality of sub-wavelength structures operable to manipulate optical signal/radiation to which metasurface structure is exposed to or irradiated with, the plurality of sub-wavelength structures being arranged such that:
the metasurface structure is operable to display a first image based on image data embedded or encoded by the sub-wavelength structures when the metasurface structure is exposed to or irradiated with a first optical signal/radiation, and
the metasurface structure is operable to display a second image based on image data embedded or encoded by the sub-wavelength structures when the metasurface structure is exposed to or irradiated with a second optical signal/radiation different from the first optical signal/radiation;
wherein the first image comprises an optical-printing image and the second image comprises one or more holographic images.

2. The metasurface structure of claim 1,
wherein the optical-printing image comprises a multi-color image; and
wherein each of the one or more holographic images comprises a monochromatic image.

3. The metasurface structure of claim 1,
wherein the first optical signal/radiation comprises white light; and
wherein the second optical signal/radiation comprises a laser with a specific combination of wavelength, polarization, spatial angle, and/or focal distance.

4. The metasurface structure of claim 3,
wherein the one or more holographic images are multiple,
wherein the second optical signal/radiation comprises lasers with different combinations of the wavelength, polarization, spatial angle, and/or focal distance such that each of the one or more holographic images is displayed when the metasurface structure is exposed to or irradiated with a laser with a respective combination of the wavelength, polarization, spatial angle, and/or focal distance, and
wherein respective colors of the one or more holographic images are different.

5. The metasurface structure of claim 1, wherein the plurality of sub-wavelength structures comprises a plurality of sub-wavelength micro-structures or nano-structures.

6. The metasurface structure of claim 1, wherein the plurality of sub-wavelength structures comprises a plurality of nano-blocks.

7. The metasurface structure of claim 6,
wherein the plurality of nano-blocks is in the form of generally rectangular prisms with height, length and width;
wherein the plurality of nano-blocks comprises:
at least one first nano-block with a first size in terms of one or more of height, length or width; and
at least one second nano-block with a second size different from the first size in terms of one or more of height, length or width, and
wherein the at least one first nano-block and the at least one second nano-block have different optical transmission and/or scattering properties.

8. The metasurface structure of claim 7,
wherein the plurality of nano-blocks further comprises:
at least one third nano-block with a third size different from the first size and the second size in terms of one or more of height, length or width;
wherein the at least one first nano-block, the at least one second nano-block, and the at least one third nano-block have different optical transmission and/or scattering properties.

9. The metasurface structure of claim 1, wherein the plurality of sub-wavelength structures is distributed evenly or unevenly.

10. The metasurface structure of claim 1, wherein the plurality of sub-wavelength structures is distributed unevenly and correspond to unevenly distributed pixels where multiple kinds of super-pixel regions are defined with the plurality of sub-wavelength structures in different sizes and filling densities.

11. The metasurface structure of claim 10, wherein the multiple kinds of super-pixel regions comprise three super-pixel regions which include an RGB region and two monochromatic regions with different pixel periods.

12. The metasurface structure of claim 11, wherein the RGB region comprises two or more sub-pixels to represent two or more different colors.

13. The metasurface structure of claim 12, wherein the optical-printing image is realized by the three super-pixel regions, and the one or more holographic images are realized by a colored super-pixels and sub-pixels of the regions.

14. The metasurface structure of claim 1, wherein the plurality of sub-wavelength structures is arranged in one monolayer.

15. The metasurface structure of claim 1, wherein the plurality of sub-wavelength structures has the same orientation or different orientations.

16. An article comprising at least one of the metasurface structure of claim 1; and optionally:
wherein the optical-printing image contains identification information, and/or
wherein the one or more holographic images contain security and/or authentication information.

17. A method for encoding information on a metasurface structure including a plurality of sub-wavelength structures, comprising:
designing and arranging the plurality of sub-wavelength structures with different chromatic responses in different regions of an optical-printing image, the different regions represent different colors constituting the optical-printing image; and
generating one or more holographic images from the different colored regions of the optical-printing image based on Pancharatnam-Berry (PB) phases of the plurality of sub-wavelength structures,
wherein the optical-printing image is displayed when the metasurface structure is exposed to or irradiated with a first optical signal/radiation, and the one or more holographic images are displayed when the metasurface structure is exposed to or irradiated with a second optical signal/radiation different from the first optical signal/radiation.

18. The method of claim 17, further comprising:
designing one or more super-pixels regions constructing the optical-printing image based on polarization conversion efficiency of the plurality of sub-wavelength structures and spatial distribution of different colors in the optical-printing image,
wherein the one or more super-pixels regions have different morphologies and arrangements of the sub-wavelength structures.

19. The method of claim 17,
wherein the optical-printing image comprises a multi-color image; and
wherein each of the one or more holographic images comprise a monochromatic image.

20. The method of claim 17,
wherein the first optical signal/radiation comprises white light; and
wherein the second optical signal/radiation comprises a laser with a specific combination of wavelength, polarization, spatial angle, and/or focal distance.

21. The method of claim 20,
wherein the one or more holographic images are multiple,
wherein the second optical signal/radiation comprises lasers with different combinations of the wavelength, polarization, spatial angle, and/or focal distance such that each of the one or more holographic images is displayed when the metasurface structure is exposed to or irradiated with a laser with a respective combination of the wavelength, polarization, spatial angle, and/or focal distance, and
wherein respective colors of the one or more holographic images are different.

22. The method of claim 17, wherein the plurality of nanostructures is in the form of generally rectangular prisms with height, length and width, and
wherein designing and arranging the plurality of sub-wavelength structures comprises selecting the plurality of sub-wavelength structures including at least one first nanostructure with a first size in terms of one or more of height, length or width, and at least one second nanostructure with a second size different from the first size in terms of one or more of height, length or width.

23. The method of claim 22, wherein the plurality of nanostructures further comprises at least one third nanostructure with a third size different from the first size and the second size in terms of one or more of height, length or width.

24. The method of claim 17, wherein designing and arranging the plurality of sub-wavelength structures comprises arranging the plurality of sub-wavelength structures to be distributed evenly or unevenly.

25. The method of claim 17, wherein designing and arranging the plurality of sub-wavelength structures comprises arranging the plurality of sub-wavelength structures to be distributed unevenly, and
wherein the plurality of sub-wavelength structures corresponds to unevenly distributed pixels where multiple kinds of super-pixel regions are defined with the plurality of sub-wavelength structures in different sizes and filling densities.

26. The method of claim 25, wherein the multiple kinds of super-pixel regions comprise three super-pixel regions which include an RGB region and two monochromatic regions with different pixel periods.

27. The method of claim 26, wherein the RGB region comprises two or more sub-pixels to represent two or more different colors.

28. The method of claim 27, wherein the optical-printing image is realized by the three super-pixel regions, and the one or more holographic images are realized by a colored super-pixels and sub-pixels of the regions.

29. The method of claim 17, wherein designing and arranging the plurality of sub-wavelength structures comprises arranging the plurality of sub-wavelength structures in one monolayer.

30. The method of claim 17, wherein designing and arranging the plurality of sub-wavelength structures comprises arranging the plurality of sub-wavelength structures to have the same orientation or different orientations.

31. The method of claim 17, wherein generating one or more holographic images comprises applying an optimized Gerchberg-Saxton (G-S) algorithm to obtain a specific combination of work condition for each of the holographic images such that each holographic image can only be read out with a specific combination of work conditions including wavelength, polarization, spatial angle, and/or focal distance.
